(19) United States
(12) Patent Application Publication
(10) Pub. No.: US 2020/0037750 A1
(43) Pub. Date: Feb. 6, 2020

(54) Caddy cover

(71) Applicant: Sheila Deborah Wilkins, Delray Beach, FL (US)

(72) Inventor: Sheila Deborah Wilkins, Delray Beach, FL (US)

(21) Appl. No.: 15/998,312

(22) Filed: Aug. 6, 2018

(51) Int. Cl. A46B 17/08

(52) U.S. Cl. CPC A46B 17/08; A61C 17/16

(57) ABSTRACT

The concept of this invention is an accessory designed for placement beneath the handle of Electric toothbrushes resting on the charging caddy. The Caddy Cover would consist of a water absorbent material containing a circular opening within its center for placement atop the pedestal. This oral care disposable product could be produced in a wide array of colors and can be available in sizes designed for placement upon various styles of electric toothbrushes. The Caddy Cover could be produced easily using conventional and readily available materials and manufacturing processes. No new production technology would be required.

This is an information summary of the product idea and the needs it may fulfill.

The concept of the Caddy Cover is an accessory designed for placement beneath the handle of Electric Toothbrushes.

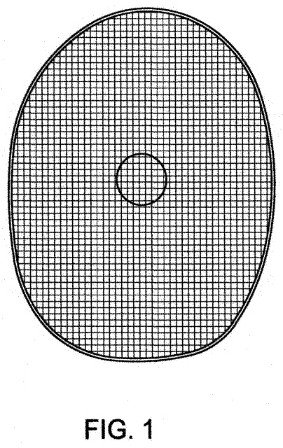

FIG. 1 The Oval shaped base pad length is 4.5 Cm
Top and Bottom width of pad 2 Cm

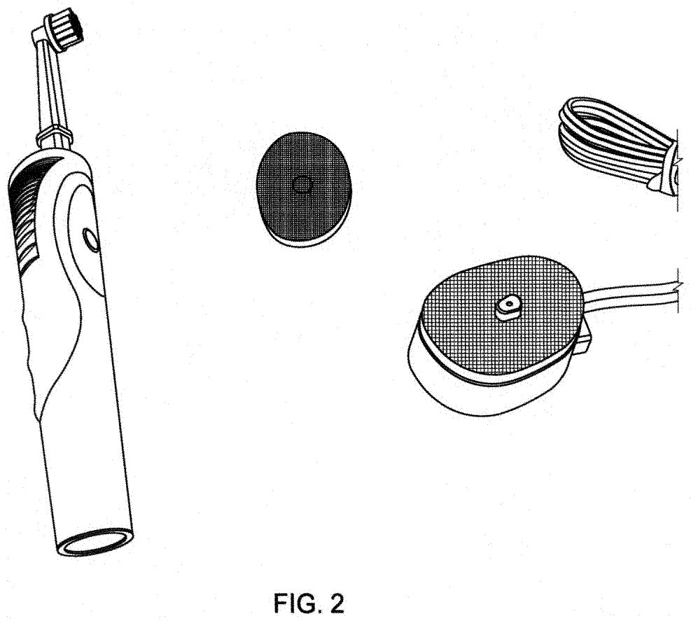

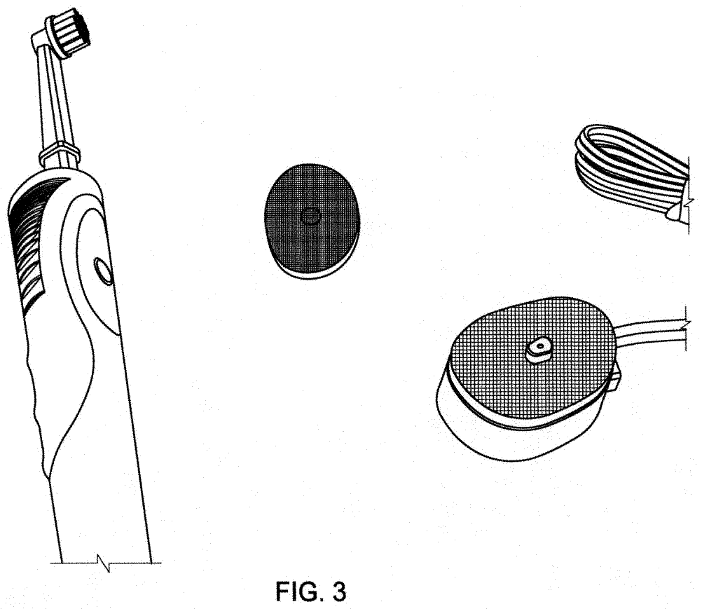

FIG. 2 Middle width of pad is 3.5 Cm
Middle perforated opening is ½ Cm

The Caddy Cover's function is to absorb any liquid runoff from brushing your teeth. This oral care disposable product can be produced in an array of colors. Also can be designed for placement upon various styles of electric toothbrushes.

The Caddy Cover will provide users with increased hygiene, cleanliness and serve as a sanitary barrier.

### The Caddy Cover

This is an information summary of the product idea and the needs it may fulfill:

The concept of the Caddy Cover is an accessory designed for placement beneath the handle of Electric Toothbrushes, such as the Oral-B.

The Caddy Cover would consist of a round section of a cross stitch fabric or any liquid absorbing material. The measures 2 s in diameter and would contain a circular opening within its center measuring ¼ inch. This opening is for placement atop the Pedestal.

### Function and Appealing Features:

The Caddy Cover's function is to absorb water or any liquid runoff. This product could appeal to those individuals who employ Electric Toothbrushes. This oral care disposable product can be produced in an array of colors and available in sizes designed for placement upon various styles of Electric Toothbrushes.

The Caddy Cover will provide users with increased Hygiene, Cleanliness, ease of use and practicality. The product will serve as a Sanitary barrier.

1. The appealing features of The Caddy Cover would be its ability to provide users with increased hygiene, cleanliness, ease of use and practicality. The design of the product would eliminate the pedestal or base of the toothbrush from being covered in water or any liquid. The Caddy Cover would serve as a sanitary barrier in which any liquid runoff would be prevented from getting all over the pedestal.
